(19) United States
(12) Patent Application Publication
(10) Pub. No.: US 2023/0392816 A1
(43) Pub. Date: Dec. 7, 2023

(54) SYSTEM FOR MIXING AIR

(71) Applicant: IMPRESIND S.R.L., Milano (IT)

(72) Inventors: Paolo Luigi CAMPOLMI, Gorgonzola (MI) (IT); Sergio SPERANI, Gorgonzola (MI) (IT)

(21) Appl. No.: 18/026,532

(22) PCT Filed: Sep. 24, 2021
(86) PCT No.: PCT/IB2021/058737

§ 371 Date: Mar. 15, 2023

(30) Foreign Application Priority Data
Sep. 30, 2020 (IT) 102020000023080

(51) Int. Cl. F24F 11/77; F24F 11/30

(52) U.S. Cl. CPC F24F 11/77; F24F 11/30; F24F 2110/10

(57) ABSTRACT

A system for mixing air in an environment comprises an air mixer comprising an adjustable speed motor and a helical-centrifugal impeller, a sensor configured to measure a parameter indicating the environmental conditions, and a control module connected to said air mixer and to said sensor. The control module is configured to receive at its input a signal from the sensor indicating the value of the parameter and to output to the mixer a control signal for adjusting the speed of the motor as a function of the value of the parameter. The impeller comprises first and second helical portions, each arranged at a respective end of a shaft which connects the impeller to the motor and comprising at least two blades, and centrifugal blades arranged in a radial position with respect to the helical portions.

### TECHNICAL FIELD

The present invention relates in general to the field of air mixing systems. In particular, the present invention relates to an air mixing system suitable for a medium/large-size environment, for example an industrial environment.

### PRIOR ART

Devices called “air mixers” are known, said devices being used to ensure the uniformity of the thermal zones at the various heights or in the different portions of the rooms in which they are installed, in particular for medium/large-size environments, such as industrial environments. In particular, air mixers which mix the surrounding air owing to a converging/diverging effect produced by a helical-centrifugal impeller, rotated by a motor, are known.

The operating principle of mixers is different from that of so-called “destratificators”. A destratificator commonly comprises an axial fan which sucks in and then dispenses the air in the same direction, namely in a direction parallel to the axis of the impeller. Such a destratificator therefore forces downwards the layer of air which is situated above the device typically in the vicinity of the ceiling of the room in which it is installed (where usually the hotter air is present). In this way, the air is transferred from the top downwards substantially inside a cylindrical volume, the diameter of which is determined essentially by the diameter of the fan. The air mixer instead acts in such a way as to ensure the uniformity of the temperature and/or humidity of the environment in which it is installed by mixing the air of the two layers, one of which is located above the mixer and the other one of which is located below the mixer. The air of these layers is sucked into the mixer in the vertical direction through the bottom and top openings in the frame of the said mixer and is distributed into the environment radially, in a centrifugal manner, by means of the rotation of the mixer impeller. In this case, the radius of action is greater than that of an axial fan. The suction of the air above and below the mixer creates two vacuum zones which recall the air distributed centrifugally, completing the ventilation cycle and therefore the mixing of the layers of air, ensuring the uniformity of the air in the environment almost at 360°.

Italian patent No. 1173562, in the name of the Applicant, describes the aforementioned converging/diverging effect and the helical-centrifugal impeller which achieves this effect.

Italian patent No. 1173563, in the name of the Applicant, describes a helical-centrifugal fan.

The following patent applications instead describe destratificator systems with axial fans.

Patent application WO 2009/100052 A1 describes a fan with a hub, various blades and a motor able to drive the hub. A controller for the motor is in communication with the motor and is configured to select the rotation speed at which the motor drives the hub. The fan is installed in a location which has a floor and a ceiling. A top temperature sensor is positioned close to the ceiling. A bottom temperature sensor is positioned close to the floor. The temperature sensors communicate with the motor controller, which includes a processor configured to compare temperature readings received substantially simultaneously from the top and bottom temperature sensors. The motor controller is therefore configured to automatically control the motor of the fan to reduce to the minimum the differences between the substantially simultaneous temperature readings from the top and bottom temperature sensors. The ventilation system may thus destratify substantially the air in an environment to ensure a substantially uniform distribution of the temperature inside the environment.

Patent application WO 2016/011040 A1 describes an environmental control system for a space comprising at least one window designed to allow light into the space. The system comprises an environmental controller (such as a fan, a light, an HVAC system, a window, a cladding for windows, or any combination of these) for regulating an environmental condition, and at least one first sensor, such as a radiant heat flow sensor, for detecting a quantity of radiant energy associated with the space and generating an output. A controller is provided to control the operation of the environmental controller depending on the sensor output.

The patent application JPH062902 (A) describes a ceiling fan installed on an internal ceiling, a means for detecting the ambient temperature of the top part, an ambient temperature detection means which detects an ambient temperature of the bottom part, an ambient temperature comparison means which compares the ambient temperatures detected and a controller which modifies an operating state of the ceiling fan depending on the results of the comparison.

The patent application JPH04251142 (A) describes a method in which the difference between the temperature detected by an internal top temperature sensor and the temperature detected by an internal bottom temperature sensor and the difference between a comfortable temperature and the temperature detected by the bottom temperature sensor is detected by the control device for a circulator.

### SUMMARY OF THE INVENTION

The Applicant has noted that the conventional air mixers do not allow automatic modulation of the intensity and/or of the moved air flowrate when there is a variation in the environmental conditions in which the device is installed, in particular when there is a variation in the physical parameters such as the humidity and temperature and/or when there is a variation in other parameters relating to the air quality.

The Applicant has moreover noted that recently there has been a growing demand for a mixer which is able not only to ensure the uniformity, in the whole area considered, of the physical parameters of the air, but also to allow the control of other measurable parameters relating to the air quality, for example the presence and/or concentration of some substances in the air, or the control of some processes, such as the dispersion and diffusion of particular substances, for example the disinfecting substances used in processes for sanitization of the room in question.

The Applicant has therefore defined the aim of providing a system for mixing air which is able to modulate in an automatic manner the intensity and/or flowrate of the moved air when there is a variation in the environmental conditions of the room in which the system is installed.

The aforementioned object, together with other objects, is achieved by a system for mixing air comprising an air mixer with a helical-centrifugal impeller and a control board for the air mixer connected to one or more sensors for measuring one or more parameters indicating the environmental conditions of the environment in which the system is installed, by means of which system it is possible to regulate the speed of the air mixer motor so as to modulate automatically the intensity and/or the flowrate of the air moved by the mixer depending on the values measured by the sensors.

According to the present invention, a system for mixing air in an environment is described, said system comprising:
an air mixer comprising an adjustable speed motor and a helical-centrifugal impeller;
a sensor configured to measure a parameter indicating the environmental conditions of the environment;
a control module connected to the air mixer and the sensor;
   wherein the control module is configured to receive at its input a signal from the sensor indicating the value of the parameter and to output to the mixer a control signal for regulating the speed of the motor as a function of the value of the parameter measured by the sensor.

The helical-centrifugal impeller comprises:
a first helical portion and a second helical portion, each being arranged at a respective end of a shaft which connects the impeller to the motor and comprising at least two blades;
centrifugal blades positioned radially with respect to the first and second helical portions, the centrifugal blades connecting the ends of the blades of the first helical portion and the second helical portion in a direction perpendicular thereto.

Preferably, the motor is an asynchronous motor. Preferably, the control module comprises an electronic board comprising a phase cutting speed regulator or an inverter for regulating the speed of the asynchronous motor.

According to other embodiments of the mixer, the motor is an electronically commutated adjustable synchronous motor or a synchronous motor of the permanent magnet type.

Preferably, the sensor is configured to measure the temperature, humidity or concentration of a given substance within the environment.

According to on embodiment of the system, the control module implements an input/output transfer function corresponding to regulation of the speed of the motor proportional to the value of the parameter measured by the sensor.

According to another embodiment, the system comprises a first sensor and a second sensor positioned in different positions in the environment and configured to measure the parameter indicating the environmental conditions of the environment, wherein the control module is configured to receive at its input a difference between the value of the parameter provided by the first sensor and the value of the parameter provided by the second sensor and to output a signal for controlling the speed of the motor dependent on this difference.

Preferably, the control module implements an input/output transfer function corresponding to regulation of the speed of the motor proportional to the value of the difference between the value of the parameter provided by the first sensor and the value of the parameter provided by the second sensor.

According to a further embodiment of the system, the control module implements a control of the PID type.

### BRIEF DESCRIPTION OF THE FIGURES

The present invention will become clearer from the following detailed description, provided purely by way of a non-limiting example, to be read with reference to the accompanying drawings, in which:

FIG. 1 schematically shows a system for mixing air according to a first embodiment of the present invention;

FIG. 2a is a schematic front view of an air mixer for the air mixing system according to the present invention, while FIG. 2b is a schematic plan view of the same mixer;

FIG. 3a is a schematic front view of the impeller for the air mixer according to the present invention; FIG. 3b is a plan view of a two-blade impeller, while FIG. 3a is a plan view of a four-blade impeller;

FIG. 4 shows a transfer function for controlling the air mixer according to the first embodiment of the system of the present invention;

FIG. 5 schematically shows a system for mixing air according to a second embodiment of the present invention; and

FIG. 6 shows a transfer function for controlling the air mixer according to the second embodiment of the system of the present invention.

### DETAILED DESCRIPTION

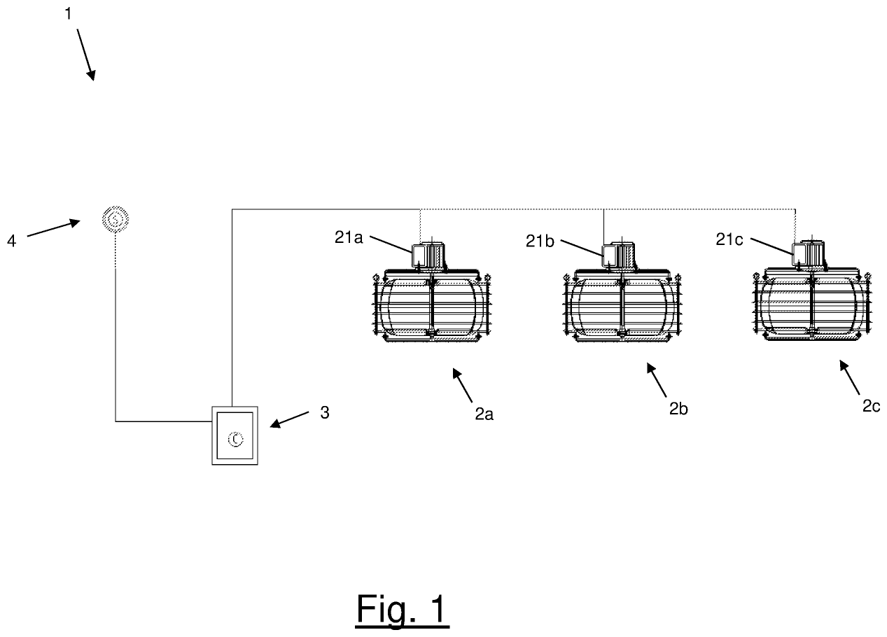

FIG. 1 shows in schematic form a system for mixing air according to an embodiment of the present invention. The air mixing system is indicated schematically by the reference number 1. It is assumed that such a system is installed in a medium/large-size environment or room for example of an industrial, commercial, agricultural or sports type, in order to mix the air in this environment and ensure the uniformity of the ambient conditions.

The system 1 according to the present invention comprises one or more devices for mixing air or air mixers 2a, 2b, 2c, a control module 3, and one or more sensors 4, The control module 3 of the system 1 is configured to be connected to the one or more sensors 4 configured to measure one or more parameters indicating the ambient conditions inside the considered environment (for example, the temperature, the humidity and/or the concentration of a given substance in the air), FIG. 1 shows by way of example three air mixers 2a, 2b and 2c. Each of the air mixers 2a, 2b, 2c is preferably provided with a control unit 21a, 21b, 21c configured to be connected, in a wired or wireless manner, to the control module 3. Also each of the sensors 4 is preferably connected, in a wired or wireless manner, to the control module 3. In particular, the control module 3 has one or more inputs connected to the sensors 4 and an output connected to the control units 21a, 21b, 21c of the air mixers 2a, 2b, 2c.

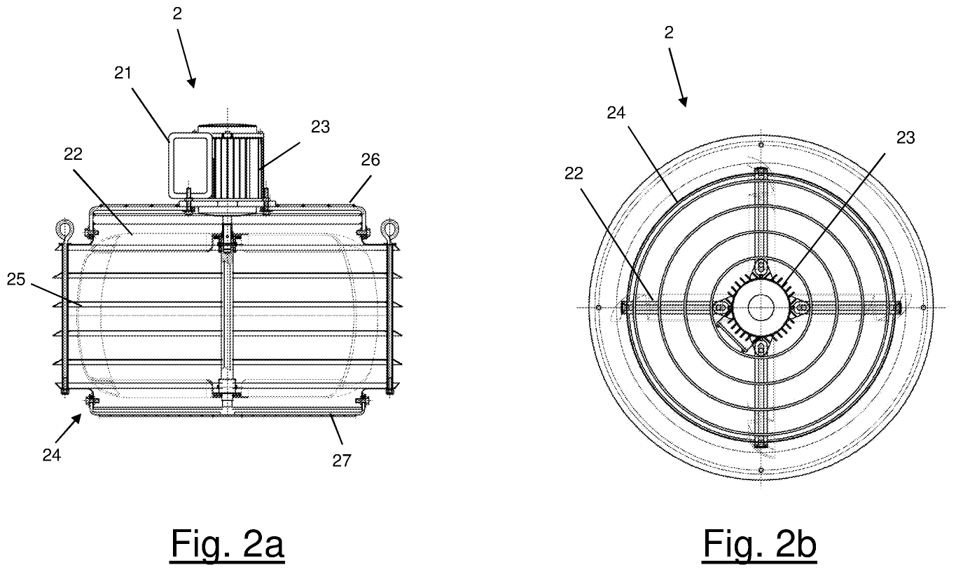

FIGS. 2a and 2b schematically show an air mixer 2 for the system 1 according to the present invention. The air mixer 2 of the system according to the present invention preferably comprises the control unit 21, a helical-centrifugal impeller 22, a motor 23 and a frame 24. The impeller 22 is driven by the motor 23. The motor 23 is an adjustable speed motor.

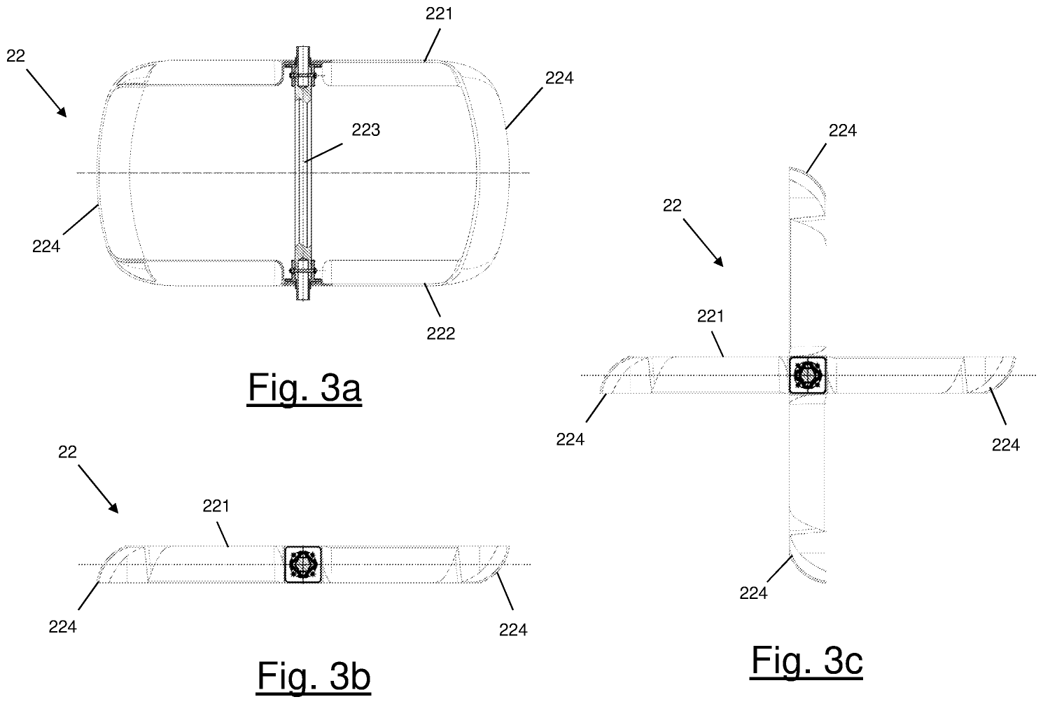

FIGS. 3a and 3b show two embodiments of the impeller 22.

The impeller 22 comprises a first helical portion 221 and a second helical portion 222 (i.e., two propellers), each of which comprises at least two blades. In the embodiment shown schematically in FIG. 3b, each helical portion of the impeller 22 comprises two blades arranged at 180° with respect to each other. In the embodiment shown schematically in FIG. 3c, each helical portion comprises four blades arranged at 90° with respect to each other. The two helical portions 221, 222 are arranged symmetrically with respect to the centre at the two ends of a shaft 223 which connects the impeller 22 to the motor 23, allowing the transmission of the circular movement. The impeller 22 preferably also comprises suitably shaped centrifugal blades 224 positioned radially with respect to the propellers 221, 222; the centrifugal blades 224 connect the ends of the blades of the first helical portion 221 and second helical portion 222 in a direction perpendicular to the said propellers.

The frame 24 acts as a support and protection for the impeller 22. The frame 24 preferably comprises lateral grilles 25, a top opening 26 and a bottom opening 27. The top and bottom openings 26, 27 have the function of optimizing the entry of the air onto the helical portions of the impeller 22. The lateral grilles 25 have a protective function and serve to direct the outgoing air flow pushed by the centrifugal blades 224 of the impeller 22.

The helical portions of the impeller 22 draw in the air and direct each air flow (i.e., the air flow sucked in by the first helical portion through the top opening 26 and the air flow sucked in by the second helical portion through the bottom opening 27) towards the centre of the impeller 22, where mixing takes place. The centrifugal blades 224 capture the air sucked in via the centre of the said impeller and distribute it radially so that the air is introduced into the surrounding environment.

The impeller 22 is preferably made as one piece from a thermoplastic material, for example polyamide with added glass fibres. Preferably, the impeller 22 is made by means of moulding of this thermoplastic material.

According to one embodiment of the present invention, the motor 23 is an asynchronous motor. In this case, the control module 3 is a module which is situated preferably externally with respect to the motor 23, as schematically shown in FIG. 1.

In this case, the control module 3 comprises an electronic control board able to vary the number of revolutions of the motor 23 by adjusting the electric power supply parameters thereof (for example the voltage or frequency). The control board preferably comprises a terminal strip for the 230 Vac, 50/60 Hz, power supply and suitable connectors for connecting the sensors 4. The board preferably also comprises a relay output for driving the air mixer and a serial port, for example of the RS-485 type, for network communication with other devices, such as a computer, by means of a serial communication protocol, for example Modbus. Furthermore, the control board comprises a device for regulating the speed of the motor, such as a phase cutting speed regulator or an inverter. The mode of operation of these types of devices is known and will not be further described below.

According to another embodiment of the present invention, the motor 23 is an electronically commutated adjustable synchronous motor (commonly known also as an EC motor). In this case, the control module 3 may be situated externally with respect to the motor or integrated in the body of the said motor.

According to a further embodiment of the present invention, the motor 23 is a synchronous motor of the permanent magnet type (commonly known as a “brushless motor”). In this case also, the control module 3 may be situated externally with respect to the motor or integrated in the body of the said motor.

As already mentioned above, each sensor 4 of the system according to the present invention may be configured to measure a parameter such as, for example, the temperature, humidity or concentration of a given substance within the environment considered. For example, the sensor 4 may be a temperature sensor comprising a PCT (Positive Temperature Coefficient) thermostat operating within the range of −50° C. to +110° C., for example a PCT probe 990Ω@25° C.

According to embodiments of the present invention, the control module 3 is preferably configured to receive an input signal (in particular a digital or analog electric signal) from each of the sensors 4 and to provide an output signal to the control unit 21 of each air mixer 2, for driving the motor 23. The output signal from the control module 3 is preferably a—digital or analog—electric control signal, for regulating the speed of the motor 23. In particular, the control module 3 is preferably configured to implement an input/output transfer function. Each input signal to the control module 3 indicates the value, time variant, measured by the respective sensor, for example a humidity or temperature or concentration value of a certain substance read by the corresponding sensor, within the environment in which the system 1 is located. The output signal is preferably a signal by means of which the speed (i.e., number of revolutions) of the motor 23 is regulated as a function of the value measured by the one or more sensors connected to the input of the control module 3.

According to the first embodiment of the present invention schematically shown in FIG. 1, the system 1 comprises a measurement sensor 4 positioned in the environment in question and configured to measure a parameter S such as, for example, the temperature, humidity or concentration of a given substance within the environment considered. According to this embodiment, the control module 3 receives at its input the signal from the sensor 4 and outputs a corresponding control signal for regulating the speed of the motor. The signal for controlling the speed of the motor, generated by the control module 3, is then sent to the control unit 21 of each air mixer 2 of the system 1. The control unit 21 of each mixer is then configured to perform regulation of the speed of the motor 23 depending on the value of the input signal measured by the sensor 4.

The control signal may be different depending on the mode for controlling the speed of the motor 23.

Let it be assumed, for example, that the parameter S measured by the measurement sensor 4 is the temperature. According to a first control mode, for a use where the environment is to be cooled, the motor 23 may be driven so as to function at a predefined fixed speed when the temperature detected by the measurement sensor 4 is higher than a first value S1 and to switch off when the temperature detected by the measurement sensor 4 falls below a second value S2 (where S2<S1).

According to a second control mode, for a use where the environment is to be heated, the motor 23 may be driven so as to function at a predefined fixed speed when the temperature detected by the measurement sensor 4 is lower than a third value S3 and to switch off when the temperature detected by the measurement sensor 4 rises above a fourth value S4 (where S3<S4).

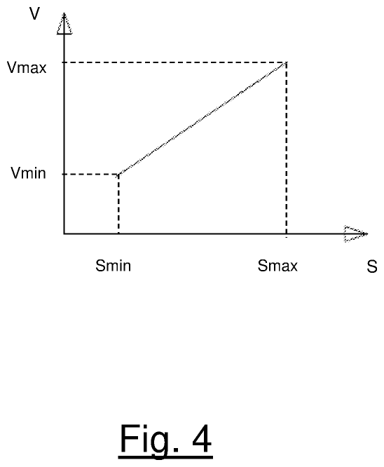

According to other control modes, the control module 3 preferably implements an input/output transfer function corresponding to a regulation of the speed of the motor 23 proportional to the value measured by the sensor 4, such as, for example, the transfer function shown in FIG. 4. FIG. 4 shows, along the x axis, the value S of the parameter (for example temperature) measured by the measurement sensors 4 and, along the y axis, the value of the speed V, in number of revolutions, of the motor 23. According to these proportional adjustment control modes, depending on the input value S of the parameter measured, and in particular within the range [Smin, Smax], where Smin and Smax are two predefined values of the parameter measured by the measurement sensor (with Smin<Smax), the speed of the motor 23 may vary between a minimum value Vmin and a maximum value Vmax corresponding to a predefined fixed speed.

In particular, according to a third control mode, for a use where the environment is to be cooled, the motor 23 may be driven so as to function at a fixed speed Vmax when the temperature measured by the measurement sensor 4 is higher than the predefined maximum value Smax and to switch off when the temperature measured by the measurement sensor 4 falls below the predefined minimum value Smin. When the temperature measured by the measurement sensor 4 is between the minimum value Smin and the maximum value Smax, the speed of the motor 23 is preferably modulated according to the transfer function shown in FIG. 4, for example between a minimum value Vmin corresponding to 1% of the fixed speed Vmax and the fixed speed Vmax.

According to a fourth control mode, for a use where the environment is to be heated, the motor 23 may be driven so as to function at a fixed speed Vmax when the temperature measured by the measurement sensor 4 is lower than the minimum value Smin and to switch off when the temperature measured by the measurement sensor 4 rises above the predefined maximum value Smax. When the temperature measured by the measurement sensor 4 is between the minimum value Smin and the maximum value Smax, the speed of the motor 23 is preferably modulated in a proportional manner between the fixed speed Vmax and the minimum value Vmin corresponding to 1% of the fixed speed Vmax.

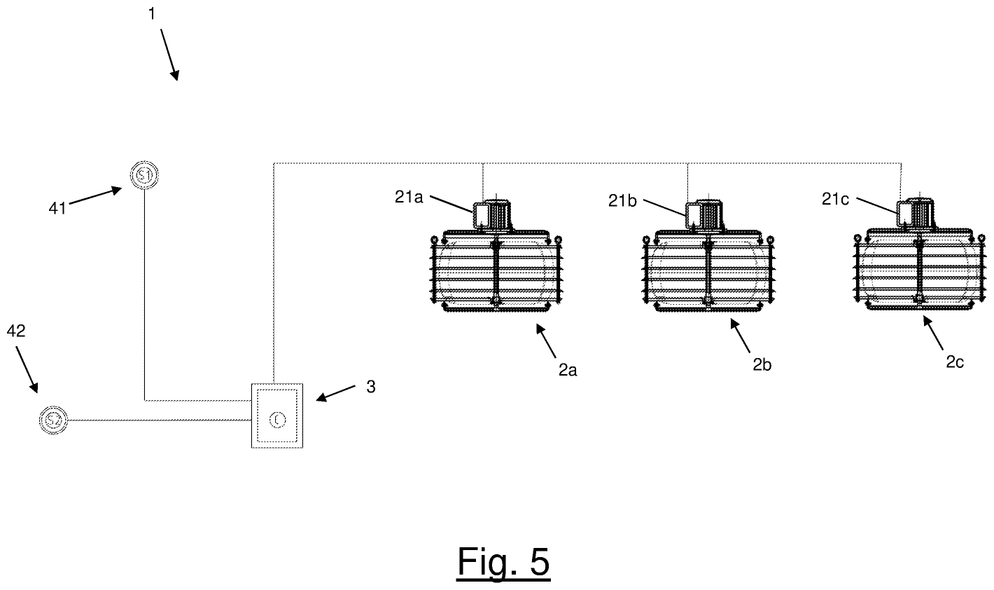

According to a second embodiment of the present invention shown schematically in FIG. 5, the system 1 comprises a first measurement sensor 41 and a second measurement sensor 42 positioned in different positions in the considered environment. The control module 3 is connected to both the first and second measurement sensors 41, 42. Each of the sensors 41, 42 is configured to measure a parameter S such as, for example, the temperature, humidity or concentration of a given substance in the considered environment. According to this embodiment, the control module 3 receives at its input the difference between the value S1 provided by the first sensor 41 and the value S2 provided by the second sensor 42. The control module 3 therefore outputs a corresponding signal for controlling the speed of the motor 23 depending on the difference between the value S1 provided by the first sensor 41 and the value S2 provided by the second sensor 42. The signal for controlling the speed of the motor, generated by the control module 3, is then sent to the control unit 21 of each air mixer 2 of the system 1. The control unit 21 of each mixer is then configured to perform the adjustment of the speed of the motor 23 depending on the difference between the input signals measured by the first sensor 41 and the second sensor 42.

In this case also, it is assumed, for example, that the parameter S measured by both the first and the second measurement sensors 41, 42 is the temperature. According to a first control mode, the motor 23 may be driven to operate at a fixed speed when the temperature difference detected by the two measurement sensors 41, 42 is greater than a first value ΔS1, and to switch off when the temperature difference detected by the two measurement sensors 41, 42 falls below a second value ΔS2, where ΔS2<ΔS1.

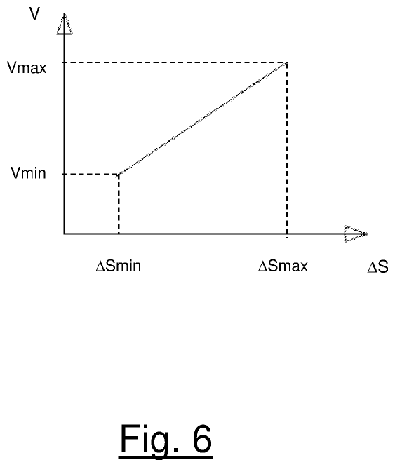

According to a second control mode, the control module 3 preferably implements an input/output transfer function corresponding to a regulation of the speed of the motor 23 proportional to the difference in the values of the parameter S measured by the first and second measurement sensors 41, 42, such as the transfer function shown in FIG. 6. FIG. 6 shows, along the x axis, the value ΔS of the difference in the values of the parameter (for example temperature) measured by the first and second measurement sensors 41, 42 and, along the y axis, the value of the speed, in number of revolutions, of the motor 23. Depending on the input value of the difference ΔS, and in particular within the range [ΔSmin, ΔSmax], where ΔSmin ed ΔSmax are two predefined values of the difference between the temperatures measured by the measurement sensors 41, 42 (where ΔSmin<ΔSmax), the speed of the motor 23 may vary from a minimum value Vmin to a maximum value Vmax corresponding to a predefined fixed speed. In this case, the motor 23 may be driven so as to function at a fixed speed Vmax when the difference between the temperatures measured by the measurement sensors 41, 42 is higher than the value ΔSmax and to switch off when the difference between the temperatures measured by the measurement sensors 41, 42 falls below the predefined minimum value ΔSmin. When the difference between the temperatures measured by the measurement sensors 41, 42 is between the minimum value ΔSmin and the maximum value ΔSmax, the speed of the motor 23 is preferably modulated according to the transfer function shown in FIG. 6, for example between a minimum value Vmin corresponding to 1% of the fixed speed Vmax and the fixed speed Vmax.

According to a third embodiment of the present invention (not shown in the figures), the control module implements a control mode of the PID (Proportional-Integral-Derivative) type. In this case, for example, the system comprises a measurement sensor positioned in the considered environment and configured to measure a parameter such as, for example, the temperature, humidity or concentration of a certain substance within the considered environment. According to this embodiment of the present invention, in particular, the control module receives at its input the value measured by the sensor and compares it with a reference value, calculating a time-variable error signal as the difference between said measured value and the reference value. The output signal of the control module 3 is calculated as the sum of a component proportional to the error signal, a component proportional to the integral over time of the error signal, and a component proportional to the derivative over time of the error signal. The signal for controlling the speed of the motor, generated by the control module, is then sent to the control unit of each air mixer of the system. The control unit of each mixer is then configured to perform the adjustment of the speed of the motor so that the value of the parameter measured by the sensor is adjusted closer to the reference value.

Advantageously, the system for mixing air according to the present invention ensures the uniformity of a parameter or a characteristic of the air in a specific environment (for example the humidity or temperature or concentration of a given substance). This results in an advantage in terms of better control of the air quality with a consequent increase in the well-being of the persons occupying the room in question. Moreover, it ensures a correct thermal/aeraulic balance in the room when there is a variation in the characteristics of the air, thus ensuring optimum use of the heating/cooling apparatuses and resulting in significant energy savings.

Moreover, advantageously, in the system according to the present invention the air mixer interacts with other thermal devices in order to obtain the measured values of the air characteristics. This allows the system to adapt automatically depending on the installation site. This constitutes a major advantage in certain production environments (such as, for example, in the agricultural/food sector) where it is of primary importance to ensure a correct thermal/aeraulic balance in the rooms when there is a variation in the temperature and/or humidity of the specific production environment.

1. A system for mixing air in an environment comprising:
an air mixer comprising an adjustable speed motor and a helical-centrifugal impeller;
a sensor configured to measure a parameter indicating the environmental conditions of said environment;
a control module connected to said air mixer and to said sensor,
wherein said control module is configured to receive an input signal from said sensor indicating the value of said parameter and to output to said air mixer a control signal for regulating the speed of said motor as a function of the value of said parameter measured by said sensor,
and wherein said helical-centrifugal impeller comprises:
a first helical portion and a second helical portion, each being arranged at a respective end of a shaft which connects the impeller to the motor and comprising at least two blades;
centrifugal blades placed in a radial position with respect to said first and second helical portions, the centrifugal blades connecting the ends of the blades of the first helical portion and the second helical portion in a direction perpendicular thereto.

2. The system according to claim 1, wherein said motor is an asynchronous motor.

3. The system according to claim 2, wherein said control module comprises an electronic board comprising a phase cutting speed regulator or an inverter for regulating the speed of said asynchronous motor.

4. The system according to claim 1, wherein said motor is an electronically commutated adjustable synchronous motor or a permanent magnet synchronous motor.

5. The system according to claim 1, wherein said sensor is configured to measure the temperature, humidity or concentration of a certain substance within said environment.

6. The system according to claim 1, wherein said control module implements an input/output transfer function corresponding to a regulation of the speed of the motor proportional to the value of said parameter measured by the sensor.

7. The system according to claim 1, said system comprising a first sensor and a second sensor positioned in different positions in said environment and configured to measure said parameter indicating the environmental conditions of said environment, wherein said control module is configured to receive at its input a difference between the value of said parameter provided by the first sensor and the value of said parameter provided by the second sensor and to output a signal for controlling the speed of the motor dependent on said difference.

8. The system according to claim 7, wherein said control module implements an input/output transfer function corresponding to a regulation of the speed of the motor proportional to the value of said difference between the value of said parameter provided by the first sensor and the value of said parameter provided by the second sensor.

9. The system according to claim 1, wherein said control module implements a control of the PID type.
